(19) United States
(12) Patent Application Publication
(10) Pub. No.: US 2004/0200762 A1
(43) Pub. Date: Oct. 14, 2004

(54) Plant for the collection and disposal of municipal waste

(76) Inventor: Aldo Frulla, Montecchio (IT)

Correspondence Address: PEARNE & GORDON LLP, 1801 EAST 9TH STREET, SUITE 1200, CLEVELAND, OH, 44114-3108, US

(21) Appl. No.: 10/486,757

(22) PCT Filed: Jun. 4, 2003
(86) PCT No.: PCT/IB03/02450

(30) Foreign Application Priority Data
Jun. 18, 2002 (IT) BO2002A000394

(51) Int. Cl. B07B 1/00

(52) U.S. Cl. 209/930; 209/233

(57) ABSTRACT

A plant (1) for the collection and disposal of municipal waste has a plurality of hoppers (2, 3, 4, 5) for accepting differentiated waste and a plurality of containers (36, 38, 39, 40) for the storage of respective types of waste; is at least partially buried with the hoppers (2, 3, 4, 5) on the surface and is equipped, in situ, with conveyor means (27, 29, 34) for transporting the waste from the hoppers (2, 3, 4, 5) to the containers (36, 38, 39, 40) and with refining systems (23, 28, 29, 35) positioned along the conveyors (27, 29, 34) for the mechanical and/or chemical and/or physical treatment of the waste.

### TECHNICAL FIELD

The present invention relates to a plant for the collection and disposal of municipal waste.

### BACKGROUND ART

In recent years growing concern for the environment has led, almost everywhere, to a differentiated collection of municipal waste and separate disposal of the different types. Each user collects the waste by dividing it into various types (indistinct wet waste, combustible waste, glass, paper, used batteries, medicines, etc.), and places them in different containers, from which the waste is then taken away for disposal and recovery if possible.

The waste, separated by type, is subjected to specific mechanical and/or chemical and/or physical treatments so as to recover the raw materials from it with the highest possible efficiency.

The waste collection and disposal operations, organised on the basis of the above-mentioned differentiation criteria, are still hindered by various practical aspects.

As regards collection, waste differentiation requires the distribution in city streets of special containers, which are often bulky and unsightly.

Moreover, at present this type of collection is left entirely to the ecological sensitivities of each user. However, each user is normally made to pay a cost determined on the basis of a simple estimate of the total quantity of waste they produce, whilst it would be desirable to define the actual quantity of each of the above-mentioned types of waste produced, in order to charge the user a more correct amount to cover the cost of collection and disposal.

In contrast, the economic return on disposal is often rather low, as it is affected by high overheads and management costs. Each type of waste requires specific collection and transportation means suitable for picking up large volumes of waste from the containers and transporting it to the respective disposal centres, normally located far away from the city.

### DISCLOSURE OF THE INVENTION

The aim of the present invention is to provide a plant for the collection and disposal of municipal waste which can satisfy the above-mentioned requirements and which, at the same time, has relatively low impact on the environment and relatively low overheads and management costs.

Accordingly, the present invention provides a plant for the collection and disposal of municipal waste as described in claim 1 and, preferably and advantageously, in any of the subsequent claims directly and/or indirectly dependent on claim 1.

### BRIEF DESCRIPTION OF THE DRAWINGS

The present invention is now described, by way of example and without in any way limiting the scope of application, with reference to the accompanying drawings, in which:

FIG. 1 is a schematic perspective view, with some parts cut away for clarity, of an embodiment of a plant made in accordance with the present invention;

FIG. 2 is a front cross-section of a first hopper illustrated in FIG. 1;

FIG. 3 is a side cross-section of the hopper illustrated in FIGS. 1 and 2;

FIG. 4 is a perspective view, with some parts cut away for clarity, of the hopper illustrated in FIGS. 1 to 3;

FIG. 5 is a perspective view, with some parts cut away for clarity, of the plant illustrated in FIG. 1 connected to the hopper illustrated in FIGS. 1 to 4;

FIG. 6 is a plan view of a detail of the plant illustrated in FIG. 1; and

FIG. 7 is a side cross-section of a second hopper illustrated in FIG. 1.

### DETAILED DESCRIPTION OF THE PREFERRED EMBODIMENTS OF THE INVENTION

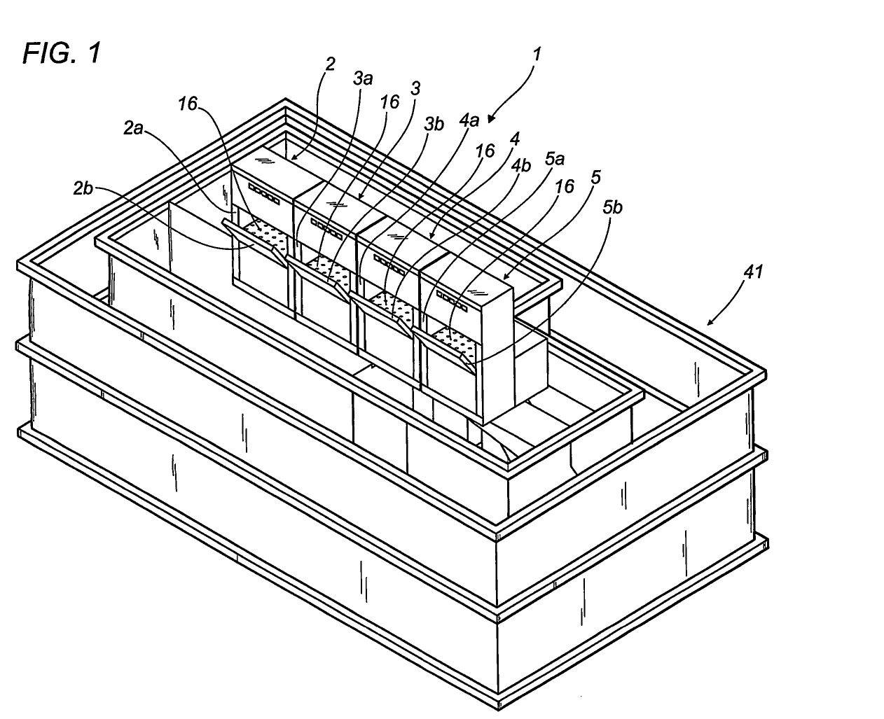

With reference to FIG. 1, the numeral 1 denotes a plant for the differentiated collection and disposal of municipal waste, that is to say, waste separated according to type. In particular, the plant 1, as described below, allows both the in situ collection and disposal of waste, since it has parts for separating the materials, for the necessary mechanical and/or chemical and/or physical treatments, for the sanitation and compacting of waste.

The plant 1, mostly made of AISI 316 L stainless steel, is completely buried, with the exception of six hoppers, each designed to receive a respective type of waste from the user. Of these six hoppers, two are not illustrated since they are simple static containers for the collection of used batteries and, respectively, medicines, whilst four, automated as described below, are labelled from 2 to 5. Of the latter, the hopper 2 is designed to receive indistinct wet waste, the hopper 3 is for combustible waste, the hopper 4 for glass and the hopper 5 for paper and cardboard.

Hereinafter, the term indistinct wet waste refers to heavy paper bags containing liquid waste, boxes, tins and drinks cans, left over food, household and garden cleaning residues, small pieces of wood without plastic, mixed wood—metal parts or plastic—metal parts, etc. Combustible waste refers to paper or plastic bags containing anything that can be burned: shoes, clothes, rags, paper which is dirty or mixed with plastic, plastic bottles or vials, pieces of wood, nappies, sanitary towels, etc. The glass to be inserted in the hopper 4 may be in the form of whole items, for example bottles, or in pieces. Such items should preferably be loose and may be either transparent or coloured. Finally, paper and card refers to clean paper items, not mixed with plastic or metal.

Each hopper 2, 3, 4, 5 has a front loading opening 2a, 3a, 4a, 5a normally closed by a door 2b, 3b, 4b, 5b which is motor-powered or has controlled opening.

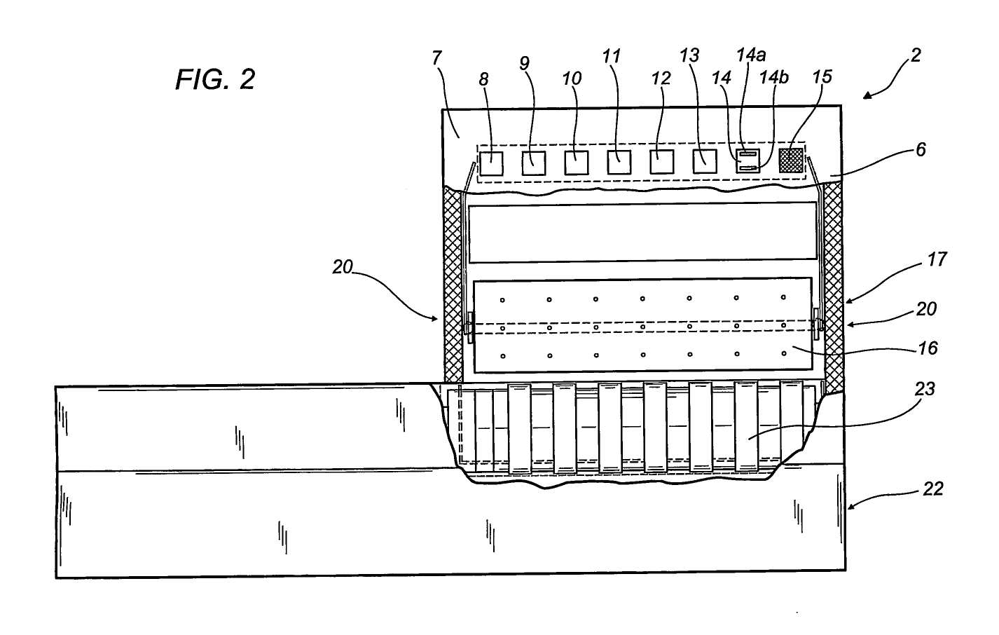

FIGS. 2, 3 and 4 illustrate details of the hopper 2, which is box-shaped with a first and a second rectangular parallelepiped connected to one another in an L-shaped configuration. Of these parallelepipeds, the first extends mainly horizontally and is behind the second, which in contrast extends mainly vertically. The second parallelepiped projects from the first with a rear panel which matches, on the opposite side, a front panel 6, open at the opening 2a and rotatably supporting the door 2b along a lower edge of the opening 2a.

Above the opening 2a, the panel 6 supports a panel 7 for interfacing with the user. The panel 7 has, in a horizontal row and front left to right, an indicator 8 of the weight of the waste inserted in the hopper 2, an indicator 9 controlled by a sensor for detecting the presence of living beings in the hopper 2, an indicator 10 controlled by a sensor for detecting the presence of explosive materials in the hopper 2, an indicator 11 controlled by a sensor for detecting the presence of weapons in the hopper 2, an indicator 12 controlled by a sensor for detecting the presence of gases and/or acids in the hopper 2, a fire alarm indicator 13, a sub-panel 14 with an infeed opening 14a for the insertion of a magnetic card identifying the user and an outfeed opening 14b for issuing a receipt, and a grille 15 covering a loudspeaker designed to give voice indications to the user.

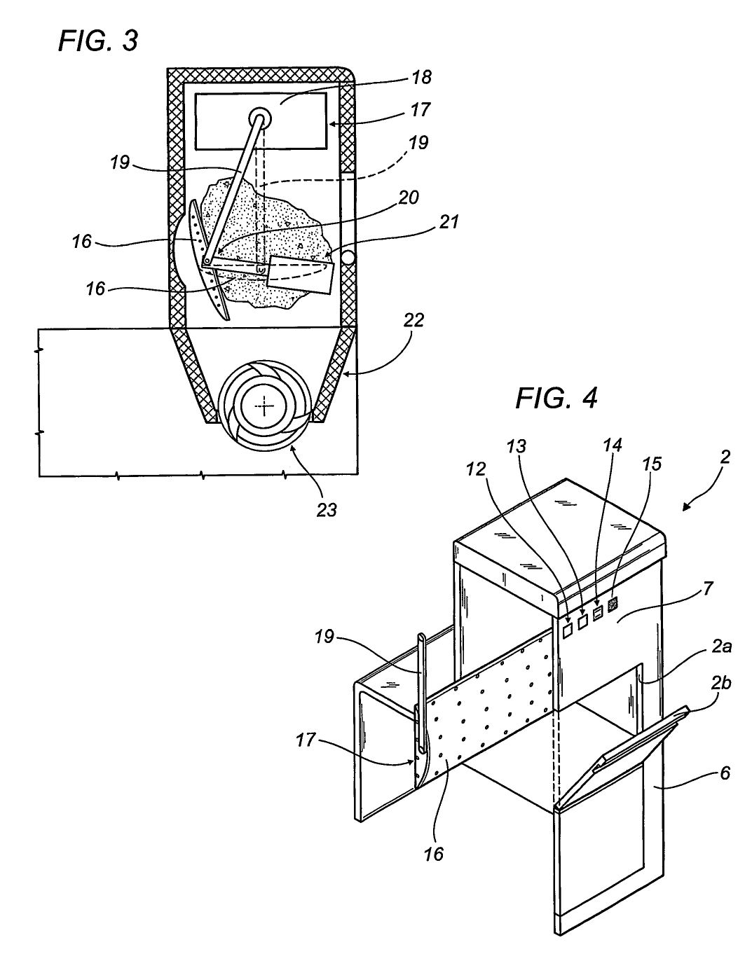

Inside the hopper 2, below the opening 2a, there is a plate 16 of a set of scales 17 connected to the indicator 8. As illustrated in FIGS. 3 and 4, the plate 16 has a plurality of through holes for draining any liquids and is supported in a suspended position by a weighing part 18 by two side arms 19 hinged on one side to the part 18 and, on the other, to the plate 16, each at a middle point of a respective side of the plate 16. At the two above-mentioned middle points the plate 16 is fixed to the arms 19 by two respective stop pins 20, which can be disconnected from the stop position by respective pusher ends of two hydraulic pistons 21. The pistons 21 are controlled by respective solenoid valves to bring the arms 19 from a first, vertical position, in which the plate 16 is connected to them in a horizontal position standing by for the waste, to a second, angled position, in which the plate 16, free to turn relative to the arms 19 and overbalanced by the waste, is in a substantially vertical position (FIGS. 2, 3 and 4) for unloading the waste to a lower container 22. The container 22 has a lower opening at which a grinder 23 operates.

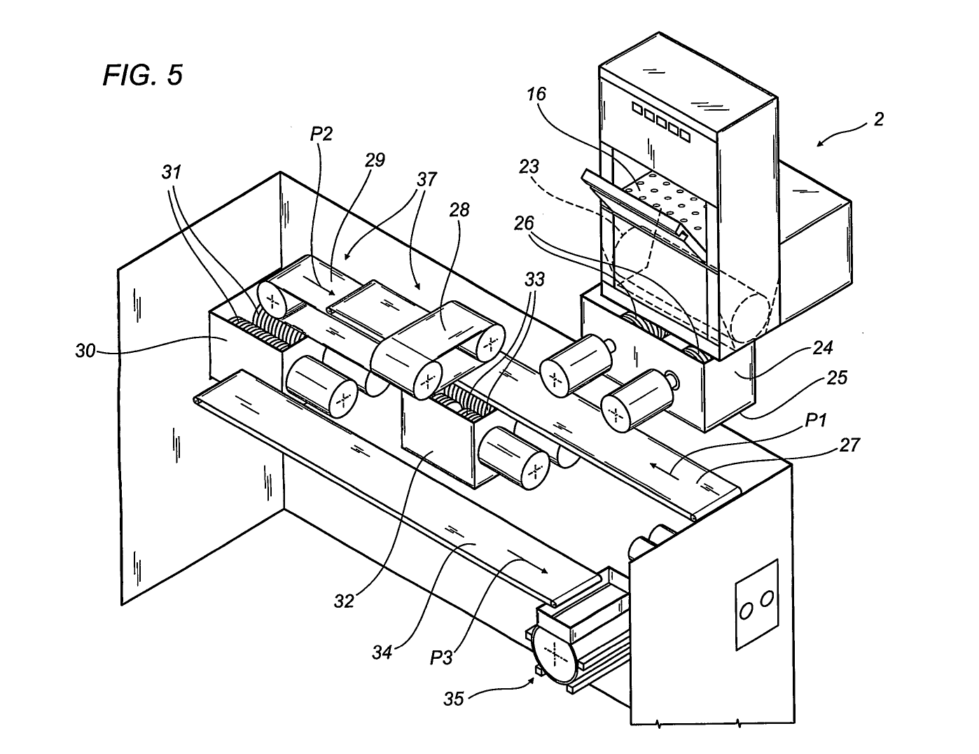

As illustrated in FIG. 5, under the grinder 23 there is another container 24 open at the top and closed at the bottom by a base 25 which can be opened. Inside the container 24 there are two motor-powered rollers 26, which rotate in opposite directions to one another and are designed to convey the ground waste towards the base 25. The latter gives onto and is over a conveyor belt 27, whose upper branch extends along a first horizontal path P1 and is motor-powered to transport the waste, along the path P1, from right to left as seen in FIG. 5. At a middle position on the path P1, above the belt 27 and transversally to it, there is a magnetic iron-remover belt 28 wound over pulleys, one of which is motor-powered. The belt 28 attracts and holds onto the iron parts from the waste transferred by the belt 27 and carries them towards a container, not illustrated. From this, in a way not illustrated, the iron parts are then picked up, subjected to high-pressure washing with water jets and high-temperature steam, ground again, filtered again magnetically to separate out any non-metal parts still stuck to the metal ones, washed again under high pressure and at a high temperature and definitively stored.

The path P1 terminates with an unloading end, positioned above an intermediate zone of another conveyor belt 29.

The belt 29, in particular made of neodymium, has an upper branch which extends along a second, horizontal path P2 and is motor-powered to transport the waste, along the path P2, from left to right as seen in FIG. 5.

The belt 29 operates by repulsion of a magnetic field and expels the non-ferrous metal materials with a force inversely proportional to their atomic weight. The trajectory of the materials expelled depends on their specific weight, therefore, there is one trajectory for aluminium, one for copper, one for brass, etc. These trajectories are intercepted by respective containers, only one of which is illustrated in FIG. 5, labelled 30. The container 30 is open, not just at the top to receive the non-ferrous metal parts from the belt 29, but also at the bottom, and, at its lower outfeed opening, has a pair of rollers 31 which rotate in opposite directions to one another, designed to release the non-ferrous metal parts to a refining path, along which there is a succession of further operations including washing, grinding, washing again, filtering by floatation, etc. When the refining of non-ferrous metal materials is complete, they are definitively stored.

The path P2 terminates with an unloading end, above a container 32. The container 32 is open, not just at the top to receive the waste from the belt 29, but also at the bottom, and, at its lower outfeed opening, has a pair of rollers 33 which rotate in opposite directions to one another, designed to release the waste to another conveyor belt 34 located below the container 32.

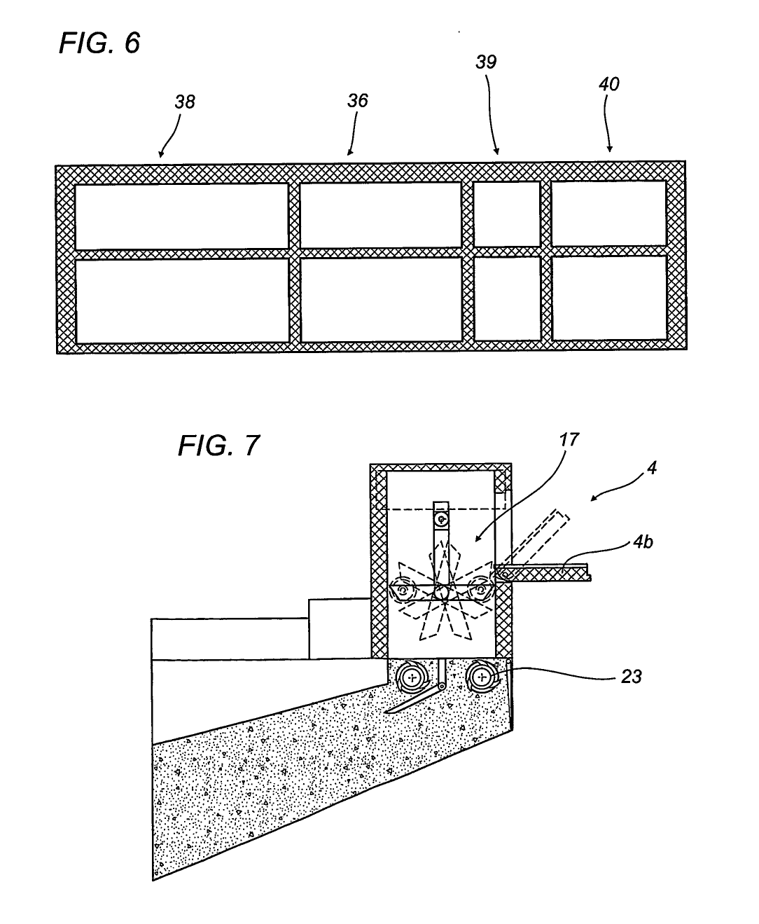

The upper branch of the belt 34 extends along a third horizontal path P3 and is motor-powered to transport the waste, along the path P3, from left to right as seen in FIG. 5. The path P3 terminates with an unloading end, which is positioned above a centrifuge 35, the latter incorporating a hammermill shredder. The centrifuge 35 pulverises the waste and deposits it in a container 36 illustrated in FIG. 6. The container 36 contains a mixer, not illustrated, which is rhythmically activated simultaneously with a pump, also not illustrated, for injecting liquid nitrogen into the mass of pulverised waste.

The belt 28 and the belt 29 act as filter means 37 for the waste which may comprise, in addition to the belts 28 and 29 and the above-mentioned filter devices, not illustrated, further devices distributed, for example, along the conveyor belt 34. These devices may be controlled by systems for detecting materials to be filtered whose operation is based on various techniques, such as the use of infrared rays, X-rays, spectroscopy, etc. These devices may also operate in conjunction with sorter robots, so that each filtered material is carried towards a respective collection container for definitive storage.

The hoppers 3, 4 and 5 are substantially the same as the hopper 2, except that they have different visual identification features, for example different colours, and so are not described in detail.

Obviously, for each of the hoppers 3, 4 and 5 there are different refining processes from those of the hopper 2, each specific to the relative type of waste. In particular, for the combustible waste put in the hopper 3, in addition to the steps of grinding, sieving and filtering, there is a step of dehumidification with jets of hot air. For paper and cardboard, there are additional steps of flotation, ink removal, elimination of glue, plastics, colorants, metals and excess water.

As illustrated in FIG. 7, the hopper 4 for glass contains a grinder 23, which is selectively fed by the plate 16 of the scales 17 which is suitably overbalanced, depending on circumstances, by the pistons 21.

As illustrated in FIG. 6, the container 36 for final storage of indistinct waste has, on one side, a container 38 for the final storage of cellulose and, on the other side, a container 39 for the final storage of glass. The container 0.39 is also alongside a container 40 for the final storage of combustible waste. The containers 36, 38, 39 and 40 are strengthened by tubular structures and are housed in an outer container 41 illustrated in FIG. 1. The tubular structures are connected to one another and form a water system, not illustrated, supplied by an artificial well for collection of water drained from the hole and any drains. This water system has a reservoir and an autoclave, not illustrated, to supply the plant 1 with the water necessary for the various washing operations described above.

In the operations which involve the user, the plant 1 operates as described below. The infeed of waste into each hopper 2, 3, 4, 5 is regulated by a magnetic card which the user must insert into the opening 14a in the sub-panel 14. When the card is inserted, the door 2b, 3b, 4b, 5b half opens, then a voice message instructs the user to open it completely, to place the waste on the plate 16 of the scales 17 and to close it again. Therefore, inside the hopper 2, 3, 4, 5 weighing takes place, involving the indicator 8, and the suitability tests are carried out, involving the indicators 9, 10, 11, 12 and 13. When the tests have been passed, the user is issued a receipt indicating the weight of the waste deposited, the type of waste and, if appropriate, a discount credited as a bonus to the user's account. For example, this bonus will be zero for indistinct waste, whilst it will be other than zero and variable according to the weight and type of the waste deposited in other cases.

In this way, the plant 1 allows the various users to be assigned a given cost, based on the weights of the waste from differentiated collection, as well as distinguishing between users more sensitive to differentiated waste collection from those less sensitive to it, rewarding the former and penalising the latter with the assignment or withholding of the above-mentioned discounts.

In a variant of the plant 1 not illustrated, even the hoppers for used batteries and medicines may be automated similarly to the hoppers 2, 3, 4, and 5, although designed to collect a smaller volume of waste than the latter.

Moreover, it should be emphasised that the above description relates to only one of the possible embodiments and applications of the present invention, numerous modifications and variants being possible, without thereby departing from the inventive concept.

Moreover, all the construction details may be substituted by technically equivalent elements.

1. A plant for the collection and disposal of municipal waste; the plant (1) comprising a plurality of hoppers (2, 3, 4, 5) for accepting differentiated waste and a plurality of containers (36, 38, 39, 40) for storing respective types of waste; the plant (1) being at least partially buried with the hoppers (2, 3, 4, 5) on the surface and being characterised in that it comprises, located in situ, conveyor means (27, 29, 34) for transporting the waste from the hoppers (2, 3, 4, 5) to the containers (36, 38, 39, 40) and refining means (23, 28, 29, 35) located along the conveyor means (27, 29, 34), for the mechanical and/or chemical and/or physical treatment of the waste.

2. The plant according to claim 1, characterised in that the refining means (23, 28, 29, 35) comprise at least one device (23, 35) for grinding the waste.

3. The plant according to claim 1, characterised in that the refining means (23, 28, 29, 35) comprise at least one filtering device (28, 29) for separating at least two constituent elements of the waste.

4. The plant according to claim 3, characterised in that the refining means (23, 28, 29, 35) comprise at least one device for sorting the waste, operating in conjunction with the filtering device (28, 29) and with the conveyor means (27, 29, 34).

5. The plant according to claim 1, characterised in that the refining means (23, 28, 29, 35) comprise at least one device for washing the waste.

6. The plant according to claim 5, characterised in that it comprises a local water system connected to the washing device.

7. The plant according to claim 1, characterised in that the refining means (23, 28, 29, 35) comprise at least one device for dehumidifying the waste.

8. The plant according to claim 1, characterised in that the containers (36, 38, 39, 40) are housed in an outer container (41).

9. The plant according to claim 1, characterised in that each hopper (2, 3, 4, 5) has a front panel (6) with a loading opening (2a, 3a, 4a, 5a), normally closed by a mechanical door (2b, 3b, 4b, 5b) with controlled opening.

10. The plant according to claim 1, characterised in that each hopper (2, 3, 4, 5) has a user interface panel (7); the panel (7) having a plurality of optical and/or sound indicators (8, 9, 10, 11, 12, 13, 15).

11. The plant according to claim 10, characterised in that the panel (7) has an infeed opening (14a) for the insertion of a magnetic card identifying the user and an outfeed opening (14b) for issuing a receipt.

12. The plant according to claim 1, characterised in that each hopper (2, 3, 4, 5) includes a plate (16) of a set of scales (17) for weighing the waste.
